(19) United States
(12) Patent Application Publication
(10) Pub. No.: US 2014/0125932 A1
(43) Pub. Date: May 8, 2014

(54) ELECTROOPTIC DEVICE AND ELECTRONIC APPARATUS

(71) Applicant: Seiko Epson Corporation, Tokyo (JP)

(72) Inventor: Yasushi Kawakami, Chino-shi (JP)

(73) Assignee: Seiko Epson Corporation, Tokyo (JP)

(21) Appl. No.: 14/048,547

(22) Filed: Oct. 8, 2013

(30) Foreign Application Priority Data
Nov. 6, 2012 (JP) 2012-244180

(51) Int. Cl. G02F 1/133; G02F 1/1335

(52) U.S. Cl. CPC G02F 1/13306; G02F 1/133512
USPC 349/110; 349/149

(57) ABSTRACT

Pixel electrodes are formed in a display region, and dummy electrodes are formed in a dummy region. A ratio of the area of the dummy electrodes in the dummy region is smaller than a ratio of the area of the pixel electrodes in the display region.

### BACKGROUND

1. Technical Field

The present invention relates to electrooptic devices and electronic apparatuses.

2. Related Art

Projectors are electronic apparatuses that irradiate a transmission-type electrooptic device, a reflection-type electrooptic device, and the like with light, and project the transmitted light, the reflected light, and the like which have been modulated by these electrooptic devices on screens. The projector is so configured as to collect light emitted from a light source to make the collected light enter an electrooptic device, and enlarge and project the transmitted or reflected light which has been modulated according to electric signals onto a screen through a projection lens. It is an advantage of the projector that images can be displayed on a larger screen. A liquid crystal device is widely known as an electrooptic device that is used in the above-mentioned electronic apparatuses. The stated liquid crystal device is configured to form an image by making use of dielectric anisotropy of liquid crystal and optical rotation of light in a crystal layer.

An example of a reflection-type liquid crystal device is described in JP-A-2012-108464. According to JP-A-2012-108464, in the liquid crystal device, pixel electrodes are arranged in matrix form at a predetermined pitch in a display region and dummy pixel electrodes are provided in a dummy display region that surrounds the display region. The dummy pixel electrodes have an equal size to that of the pixel electrodes and are arranged in island form at a pitch equal to that of the pixel electrodes; the dummy pixel electrodes are interconnected through wiring in a lower layer. A predetermined potential is supplied to the dummy pixel electrodes so that the dummy display region is displayed in black.

However, in the liquid crystal device described in JP-A-2012-108464, there has been a problem that a circuit configuration, a driving system, and the like are undesirably complicated to display the dummy display region in black. FIGS. 8A and 8B are diagrams illustrating voltage-reflectance characteristics of a liquid crystal device; FIG. 8A shows an ideal state, while FIG. 8B shows a state apart from the ideal state. In FIGS. 8A and 8B, a horizontal axis indicates a voltage applied to the crystal layer, and a vertical axis indicates a relative reflectance in which normalization is performed so that a minimum reflectance is 0% and a maximum reflectance is 100%. As shown in FIG. 8A, in the case of a normally black mode in an ideal state, the reflectance is 0% at a voltage of zero, then gradually increases as the voltage is higher, and is finally saturated at 100%. In reality, however, as shown in FIG. 8B, there is a case in which the reflectance takes a minimum value of 0% not at a voltage of zero but at a voltage Vm, due to various factors such as a pre-tilt angle which depends on liquid crystal characteristics, alignment layer manufacturing conditions, and so on. In such case, a potential that causes a voltage applied to the crystal layer to be +Vm and a potential that causes that voltage to be −Vm are alternately switched at every frame to be supplied to the dummy pixel electrodes in the liquid crystal device of the past. Accordingly, there has been such a problem in the liquid crystal device of the past that a dedicated circuit need be configured and a complicated driving system need be adopted to display the dummy display region in black.

### SUMMARY

An advantage of some aspects of the invention is to provide an electrooptic device and an electronic apparatus in order to solve at least part of the above problem, and the invention can be embodied as the embodiments or application examples described hereinafter.

An electrooptic device according to an application example of the invention includes a first substrate, a second substrate that is disposed facing the first substrate, an electrooptic material sandwiched between the first substrate and the second substrate; the first substrate includes a display region and a dummy region that is provided in a surrounding area of the display region; pixel electrodes electrically connected with switching elements are formed in the display region; dummy electrodes to which a first potential is supplied are formed in the dummy region; and a ratio of the area of the dummy electrodes in the dummy region (dummy electrode density) is smaller than a ratio of the area of the pixel electrodes in the display region (pixel electrode density).

In the case where a reflection-type electrooptic device takes a configuration in which pixel electrodes and dummy electrodes are used as reflecting plates with respect to incident light, it is possible to lower a mean reflectance in the dummy region because the dummy electrode density is low. In the electrooptic device, an electrooptic material is disposed between a common electrode and the pixel and dummy electrodes, and differences in potential between the potential of the common electrode and the potentials of the pixel and dummy electrodes become the voltages applied to the electrooptic material. With this configuration, even if the reflectance of the electrooptic device driven in the normally black mode takes a minimum value of 0% at the voltage Vm, which is applied to the electrooptic material and is not 0 volt, it is possible to lower the reflectance at the time of black display only by making the potential of the dummy electrodes equal to the potential of the common electrode. In other words, the dummy display region can be displayed in black with a low reflectance without configuring a dedicated circuit or adopting a complicated driving system.

In the electrooptic device according to the above application example, it is preferable that the ratio of the area of the dummy electrodes in the dummy region (dummy electrode density) be larger than 0.5 times and less than 1 time the pixel electrode density.

With this configuration, it is possible to form the dummy electrodes based on a minimum design rule in the manufacture of the electrooptic device.

In the electrooptic device according to the above application example, it is preferable that a width in a plan view of a space where no dummy electrode is formed in the dummy region be substantially equal to a width in a plan view of a space where no pixel electrode is formed in the display region.

With this configuration, it is possible to form the dummy electrodes based on the minimum design rule in the manufacture of the electrooptic device.

In the electrooptic device according to the above application example, it is preferable that the second substrate include an opening region and a parting region provided in a surrounding area of the opening region, and a boundary between the opening region and the parting region overlap with the dummy region in a plan view.

With this configuration, since the boundary between the opening region and the parting region is arranged in the dummy region that is displayed in black, the boundary between the opening region and the parting region is unlikely to be recognized by a user. To rephrase, an electrooptic device with high display quality can be provided.

In the electrooptic device according to the above application example, it is preferable that the opening region have a light transmitting property and the parting region have a light blocking property.

With this configuration, the opening region includes the display region and a part of the dummy region displayed in black, and the other part thereof is optically blocked by the parting region. In other words, because the surrounding area of the display region is optically blocked by the dummy region displayed in black and the parting region, it is possible to display only the display region within the opening region. Through this, an electrooptic device with high display quality can be provided.

According to another application example of the invention, there is provided an electronic apparatus including any one of the electrooptic devices described in the above application examples.

With this configuration, it is possible to provide an electronic apparatus that includes an electrooptic device with high display quality.

### BRIEF DESCRIPTION OF THE DRAWINGS

The invention will be described with reference to the accompanying drawings, wherein like numbers reference like elements.

FIGS. 1A and 1B are descriptive views illustrating the configuration of a liquid crystal device; FIG. 1A is a plan view and FIG. 1B is a cross-sectional view taken along a line IB-IB in FIG. 1A.

FIG. 2 is an equivalent circuit diagram illustrating the electric configuration of a liquid crystal device.

FIG. 3 is a cross-sectional view illustrating the structure in a display region of a liquid crystal device.

FIG. 4 is a descriptive view illustrating a display shape of an electrooptic device in a plan view from an incident light side.

FIG. 5A is a descriptive view illustrating an example of a shape of a pixel electrode in a plan view; FIG. 5B is a descriptive view illustrating an example of a shape of a dummy electrode in a plan view.

FIG. 6 is a schematic diagram illustrating the configuration of a projection-type display apparatus as an electronic apparatus.

FIG. 7 is a descriptive view illustrating an example of a shape of a dummy electrode in a plan view.

FIGS. 8A and 8B are diagrams illustrating voltage-reflectance characteristics of a liquid crystal device.

### DESCRIPTION OF EXEMPLARY EMBODIMENTS

Hereinafter, an embodiment of the invention will be described with reference to the drawings. Note that in the drawings described below, the scales of respective layers, members, and so on are different from the actual ones in order to make those layers, members, and so on larger to an extent that they can be visually recognized.

### First Embodiment

### Outline of Electrooptic Device

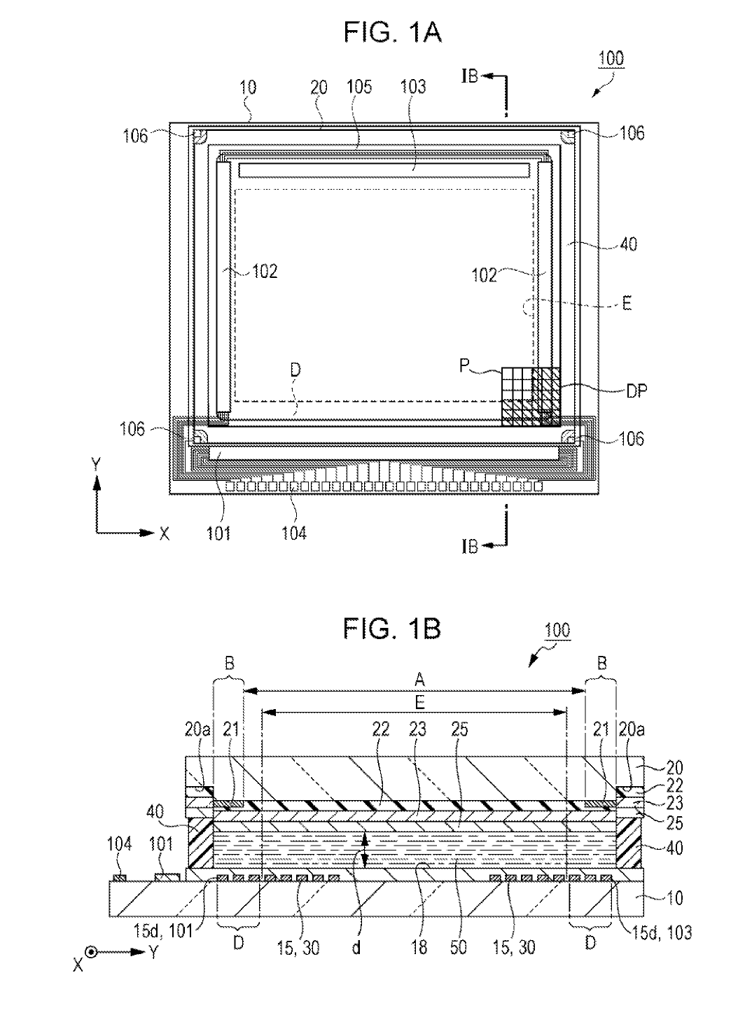

FIGS. 1A and 1B are descriptive views illustrating the configuration of a liquid crystal device; FIG. 1A is a plan view and FIG. 1B is a cross-sectional view taken along a line IB-IB in FIG. 1A. First, an outline of an electrooptic device will be described with reference to FIGS. 1A and 1B. In this embodiment, the electrooptic device is a reflection-type liquid crystal device 100, and the stated liquid crystal device 100 is equipped with thin film transistors (TFTs) 30 as pixel switching elements. In the drawings that are referred to in the following descriptions, when the layers formed on an element substrate are discussed, an upper layer side or a surface side means the opposite side to a side on which a substrate base of the element substrate is positioned (that is, a side on which an opposite substrate is positioned), while a lower layer side means the side on which the substrate base of the element substrate is positioned. Meanwhile, when the layers formed on the opposite substrate are discussed, an upper layer side or a surface side means the opposite side to a side on which a substrate base of the opposite substrate is positioned (that is, a side on which the element substrate is positioned), while a lower layer side means the side on which the substrate base of the opposite substrate is positioned.

As shown in FIGS. 1A and 1B, the electrooptic device (liquid crystal device 100) includes a first substrate (element substrate 10), a light transmitting second substrate (opposite substrate 20) that is disposed facing the first substrate, and an electrooptic material (liquid crystal layer 50) sandwiched between the first substrate and the second substrate.

The element substrate 10 can use, for example, transparent quartz glass, non-alkali glass, an opaque silicon substrate, or the like, and is a size larger than the opposite substrate 20. Further, the element substrate 10 is bonded to the opposite substrate 20 via a seal member 40 that is disposed seamlessly along an outer circumference of the opposite substrate 20. Liquid crystal having a negative dielectric anisotropy is injected into a region surrounded by the seal member 40 to form the liquid crystal layer 50. The injection (filling) of the liquid crystal to the space between the element substrate 10 and the opposite substrate 20 is carried out by one drop fill method (ODF method). The one drop fill method is a method in which the seal member 40 is disposed along an outer circumference of one substrate (element substrate 10 in this embodiment), the disposed seal member 40 serves as a bank inside of which a predetermined amount of liquid crystal is dropped, and then the one substrate and the other substrate are bonded together under reduced pressure. As the seal member 40, for example, an adhesive formed of a thermosetting or ultraviolet curing epoxy resin or the like is employed. A spacer (not shown) is mixed in the seal member 40 so as to maintain the interval between the element substrate 10 and the opposite substrate 20 to be constant.

The first substrate includes a display region E and a dummy region (peripheral region) D that is provided in a surrounding area of the display region E. More specifically, in the first substrate, the dummy region D is disposed inside the seal member 40 so as to surround the display region E. A plurality of pixels P are disposed in matrix form in the display region E; a pixel electrode 15 connected with a switching element (TFT 30) is formed in each of the pixels P. Meanwhile, a plurality of dummy pixels DP are also disposed in matrix form in the dummy region D; dummy electrodes (peripheral electrodes) 15d to which a first potential is supplied are formed in the dummy pixels DP. That is, the display region E is a region in which the plurality of pixels P are disposed and various kinds of images can be displayed. On the other hand, the dummy region D is a region where the plurality of dummy pixels DP are disposed and a constant-tone display is performed in the overall dummy region D. In this embodiment, dark display (black display) is performed in the dummy region D.

A signal line driving circuit 101 is provided at a location between one side portion (lower side in FIG. 1A) and the display region E. The seal member 40 along the lower side and the signal line driving circuit 101 partly overlap with each other in a plan view. Further, a diagnostic circuit 103 is provided at a location between the display region E and the inside of the seal member 40 that extends along another side portion (upper side in FIG. 1A) opposed to the one side portion (lower side in FIG. 1A). Furthermore, scanning line driving circuits 102 are provided at the inside of the seal member 40 that extends along other two side portions (right and left sides in FIG. 1A) which are opposed to each other and perpendicular to the above-mentioned side portions (upper and lower sides in FIG. 1A). A plurality of wires 105 configured to connect the two scanning line driving circuits 102 to each other are provided at the inside of the seal member 40 that extends along the upper side portion in FIG. 1A. The wires 105, which are connected with the signal line driving circuit 101 and the scanning line driving circuits 102, are connected to a plurality of external connection terminals 104 arranged along the lower side portion. Note that in the following descriptions, a direction along the upper and lower sides is referred to as an X direction, and a direction along the right and left sides is referred to as a Y direction. As described above, part of the signal line driving circuit 101, the scanning line driving circuits 102, the diagnostic circuit 103, and the various kinds of wires 105 are provided on the element substrate 10 in a region that is present inside the seal member 40 and outside the display region E. This region corresponds to the dummy region D. In other words, in a cross-sectional structure, the dummy pixels DP are disposed in an upper layer of the part of the signal line driving circuit 101, the scanning line driving circuits 102, the diagnostic circuit 103, and the various kinds of wires 105. Note that in FIGS. 1A and 1B, not all of the pixels P and dummy pixels DP are illustrated, that is, part of them are illustrated for the sake of facilitating the understanding of the explanation.

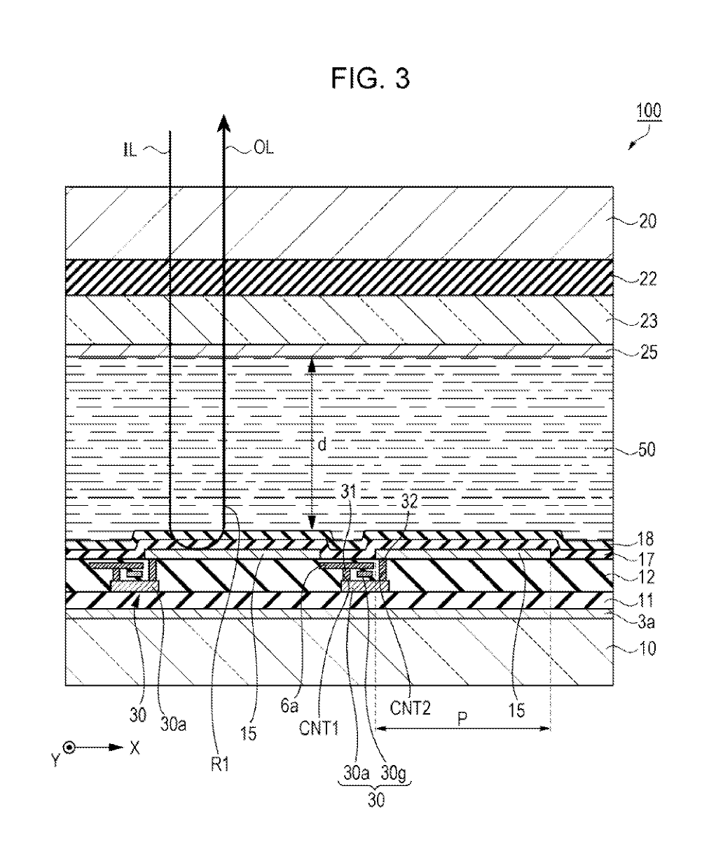

As shown in FIG. 1B, on a surface on the liquid crystal layer 50 side of the element substrate 10, there are formed the light-reflective pixel electrodes 15 that are provided to each of the pixels P, the light-reflective dummy electrodes 15d that are provided to each of the dummy pixels DP, the TFTs 30 as the switching elements, the various kinds of wires 105, a flattening insulation film 17 (see FIG. 3) that covers the pixel electrodes 15 and the dummy electrodes 15d, and an alignment layer 18. The pixel electrodes 15, the dummy electrodes 15d, and the like are formed by using, for example, light-reflective materials such as aluminum (Al), silver (Ag), an alloy of these metals, or a compound such as oxide. The pixel electrodes 15 and the dummy electrodes 15d are formed on the same layer using the same material and having the same film thickness. Through this, the flattening insulation film 17 that covers the pixel electrodes 15 and the dummy electrodes 15d, and the alignment layer 18 are flattened in a region inside the seal member 40 of the element substrate 10. In other words, the liquid crystal device 100 is a reflection-type electrooptic device in which the pixel electrodes 15 and the dummy electrodes 15d are used as reflecting plates with respect to incident light from a second substrate side. If light enters into a semiconductor layer of the TFT 30, a light leak current flows and causes inadequate switching operation to occur. Accordingly, a light blocking structure is employed in the device so as to prevent the occurrence of such inadequate switching operation.

In the formation of the second substrate (opposite substrate 20), transparent quartz glass, non-alkali glass, or the like can be used, for example; in this embodiment, quartz glass is used. The second substrate includes an opening region A and a parting region B that is provided in a surrounding area of the opening region A. A boundary between the opening region A and the parting region B overlaps with the dummy region D in a plan view. In a surface on the liquid crystal layer 50 side of the opposite substrate 20, there is formed a parting section 21 in the parting region B. Further, in the surface on the liquid crystal layer 50 side of the opposite substrate 20, there are formed a transparent insulation film 22 that covers the parting section 21 to flatten the opening region A, a transparent conductive film 23 that is so provided as to cover the transparent insulation film 22 at least across the opening region A, and an alignment layer 25 that covers the transparent conductive film 23. The transparent conductive film 23 functions as a common electrode. As described thus far, in the electrooptic device, there is disposed the electrooptic material (liquid crystal layer 50) between the common electrode (transparent conductive film 23) and the pixel electrodes 15, the dummy electrodes 15d, and the like; differences in potential between the common electrode and the pixel electrodes 15, the dummy electrodes 15d, and the like become the voltages applied to the electrooptic material. The optical characteristics of the electrooptic material vary in accordance with the applied voltages, thereby making it possible to perform display operation.

The parting section 21 has a light blocking property and is made of metal, metal oxide, or the like. As shown in FIG. 1B, the parting section 21 is provided at a location where it overlaps with part of the signal line driving circuit 101, the diagnostic circuit 103, and the like when viewed from above. That is, the boundary between the opening region A and the parting region B is provided in the dummy region D displayed in black. Through this, the device is so configured as to block incident light coming from the opposite substrate 20 side and prevent the light from causing failure operation in the peripheral circuits including the above driving circuits, and to make the boundary between the opening region and the parting region unlikely to be recognized by a user. In addition, unnecessary stray light is blocked from entering the display region E to ensure high contrast in the display region E. Although not illustrated in FIGS. 1A and 1B, there are provided a light shield configured to define the pixels P two-dimensionally in the display region E and another light shield (black matrix; BM) configured to define the dummy pixels DP two-dimensionally in the dummy region D.

The transparent conductive film 23 and the transparent insulation film 22 are configured to have a high light transmittance at visible light wavelengths. As described earlier, the opening region A has a light transmitting property, while the parting region B has a light blocking property. The transparent conductive film 23 is electrically connected with the wires in the element substrate 10 via conductive through-holes 106 that are provided in four corners of the opposite substrate 20.

The alignment layer 18 of the element substrate 10 and the alignment layer 25 of the opposite substrate 20 are set in accordance with optical deign of the liquid crystal device 100. In this embodiment, an inorganic material such as silicon oxide (SiOₓ) is deposited by a physical vapor-phase deposition method (oblique deposition, oblique sputtering, or the like) so as to be the alignment layer 18, the alignment layer 25, and the like. Liquid crystal molecules are aligned in a predetermined direction by the alignment layer 18, the alignment layer 25, and the like while forming a pre-tilt angle with respect to the alignment layer surface.

The opposite substrate 20 has a recess 20a formed in a constant depth at a portion overlapping with the seal member 40 when viewed from above. The recess 20a is formed in an area from the outside of the parting section 21 of the opposite substrate 20 to the outer circumference of the substrate. The transparent insulation film 22, the transparent conductive film 23, and the alignment layer 25 are also formed respectively on the recess 20a. In the case where the element substrate 10 and the opposite substrate 20 are disposed facing each other while sandwiching the liquid crystal layer 50 therebetween, and if thickness of the liquid crystal layer 50 is taken as “d”, a spacer (not shown) with a diameter larger than the thickness “d” of the liquid crystal layer 50 is included in the seal member 40 while taking into consideration the depth of the recess 20a. Because the transparent insulation film 22 is provided on the opposite substrate 20 for the flattening and the flattening insulation film 17 that covers the pixel electrodes 15 and the dummy electrodes 15d is provided on the element substrate 10, variation in thickness of the liquid crystal layer 50 is suppressed at least across the overall opening region A.

### Circuit Configuration

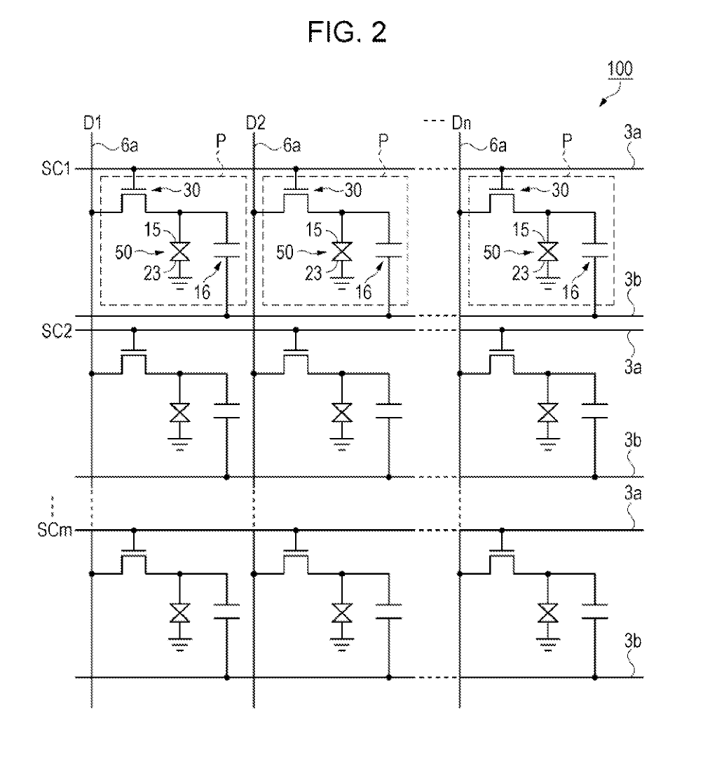

FIG. 2 is an equivalent circuit diagram illustrating the electric configuration of the liquid crystal device. Next, the circuit configuration will be described with reference to FIG. 2.

As shown in FIG. 2, the liquid crystal device 100 includes, at least in the display region E, a plurality of scanning lines 3a and a plurality of signal lines 6a that are insulated from and perpendicular to each other, and capacity lines 3b arranged in parallel to the scanning lines 3a. Note that the arrangement of the capacity lines 3b is not limited to the above-described arrangement, and the capacity lines 3b may be arranged in parallel to the signal lines 6a.

In a region partitioned by the scanning lines 3a and the signal lines 6b, the pixel electrodes 15, the TFTs 30, and retention capacitors 16 are provided so as to configure respective pixel circuits of the pixels P.

The scanning line 3a is electrically connected with a gate electrode 30g of the TFT 30 (see FIG. 3), and the signal line 6a is electrically connected with a source region of the TFT 30 in each pixel circuit. The pixel electrode 15 is electrically connected with a drain region of the TFT 30.

The signal lines 6a are connected with the signal line driving circuit 101 so as to supply image signals D1, D2, . . . , Dn delivered from the signal line driving circuit 101 to the pixels P. The scanning lines 3a are connected with the scanning line driving circuits 102 so as to supply scanning signals SC1, SC2, . . . , SCm delivered from the scanning line driving circuits 102 to the pixels P. The image signals D1 through Dn delivered from the signal line driving circuit 101 to the signal lines 6a may be delivered to each of the signal lines 6a in sequence; alternatively, the plurality of signal lines 6a may be divided into several groups and the image signals may be delivered respectively to each of the groups. The scanning line driving circuits 102 deliver the scanning signals SC1 through SCm to the scanning lines 3s so as to select one or plural scanning lines 3a in sequence.

In the pixel P at a location of i-th row and j-th column (“i” is an integer from 1 to m, “j” is an integer from 1 to n), the TFT 30 is switched to an ON state during a period in which the scanning signal SCi is a selection signal (selected period) and then the image signal Dj is supplied to the pixel electrode 15 from the signal line 6a via the TFT 30. In this manner, the pixel electrode 15 is supplied with a potential corresponding to the image signal Dj during the selected period, and an optical state of the liquid crystal layer 50 is determined in accordance with a potential difference between the pixel electrode 15 and the common electrode. During a period in which the scanning line SCi is a non-selection signal (non-selected period), the TFT 30 is switched to an OFF state and the potential of the pixel electrode 15 is retained. In order to lessen a potential fluctuation of the pixel electrode 15 during the non-selected period, the retention capacitor 16 is connected in parallel to a crystal capacitor formed between the pixel electrode 15 and the common electrode (transparent conductive film 23). The retention capacitor 16 is provided between the drain region of the TFT 30 and the capacity line 3b.

The signal lines 6a are connected to the diagnostic circuit 103 shown in FIG. 1A. Although the diagnostic circuit 103 is so configured as to determine whether or not there exists any operational defect or the like in the liquid crystal device 100 by detecting diagnostic signals during a manufacturing process of the liquid crystal device 100, the circuit configuration thereof is omitted in the equivalent circuit diagram of FIG. 2. The diagnostic circuit 103 may be so configured as to include a sampling circuit that samples the diagnostic signals and supplies the sampling result to the signal lines 6a, and a pre-charge circuit that supplies a pre-charge signal of a predetermined voltage level to the signal lines 6a prior to the diagnostic signals.

The liquid crystal device 100 discussed above is a reflection type and adopts a normally black mode optical design in which the pixel P is displayed in dark color at the time of the pixel P being not driven. A polarizing element is disposed on the incident side (or output side) of light in accordance with the optical design. “The time of the pixel P being not driven” refers to a state in which the potential of the pixel electrode 15 and the potential of the common electrode are substantially the same so that a voltage applied to the liquid crystal layer 50 is substantially zero.

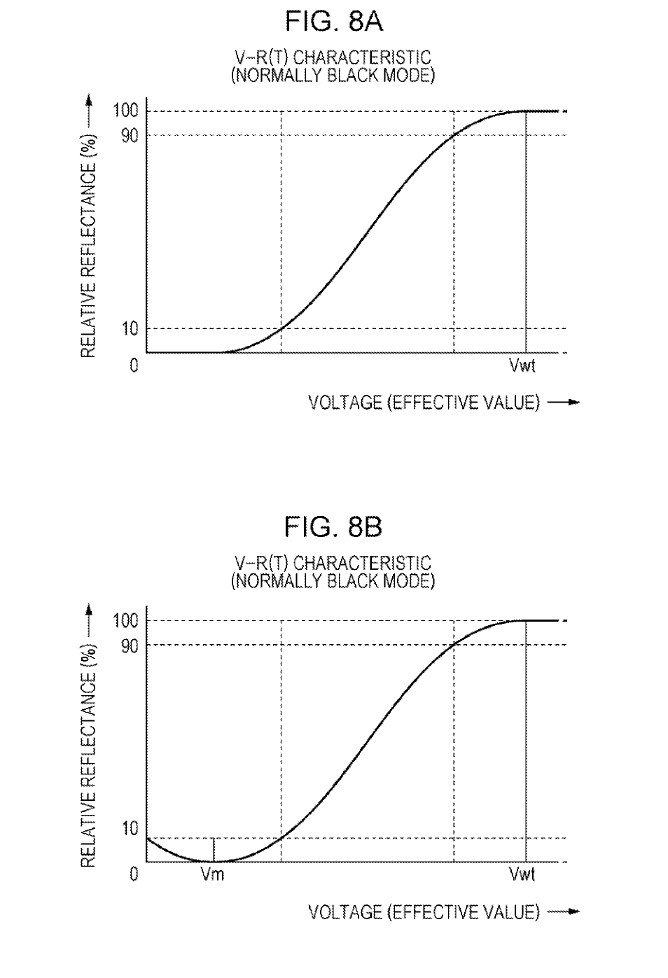

In order to display the pixel P in dark color, a potential at which the reflectance indicated in the diagrams of voltage-reflectance characteristics of FIGS. 8A and 8B becomes substantially zero, is supplied to the pixel electrode 15. That is, in order to display the pixel P in dark color in an ideal system, as shown in FIG. 8A, a potential which is substantially the same as the potential of the common electrode is supplied to the pixel electrode 15 as an image signal to make an effective voltage (voltage applied to the liquid crystal layer 50) substantially zero. As shown in FIG. 8B, in the case where the reflectance of the electrooptic device driven in the normally black mode takes a minimum value of 0% at a voltage Vm, which is applied to the electrooptic material and not 0 volt, a potential incremented by +Vm or −Vm with respect to the potential of the common electrode is supplied to the pixel electrode 15 to make the effective voltage be Vm so as to display the pixel P in dark color. Through this, the reflectance takes a value close to the minimum 0% when the pixel P is displayed in dark color. Meanwhile, in this embodiment, a first potential supplied to the dummy electrodes 15d is the same as the potential of the common electrode. In other words, by simply making the potential of the dummy electrodes 15d and the potential of the common electrode be the same, the voltage applied to the electrooptic material is made to be zero, without configuring a dedicated circuit to the dummy electrodes or adopting a complicated driving system.

### Cross-Sectional Structure

FIG. 3 is a cross-sectional view illustrating the structure in the display region of the liquid crystal device. Note that the cross-sectional structure of the liquid crystal device in the display region E and the cross-sectional structure thereof in the dummy region D are substantially the same. Next, detailed description of the cross-sectional structure of the liquid crystal device will be given with reference to FIG. 3.

As shown in FIG. 3, in the display region E, there are provided the scanning line 3a, a first interlayer insulation film 11 that covers the scanning line 3a, the TFTs 30, a second interlayer insulation film 12 that covers the TFTs 30, the pixel electrodes 15, the flattening insulation film 17 that covers the pixel electrodes 15, and the alignment layer 18 in that order on the element substrate 10. In the dummy region D, various kinds of circuits are formed using the same thin film transistor as the TFT 30, and the dummy electrodes 15d are formed in place of the pixel electrodes 15.

The scanning line 3a also serves as a light blocking film that blocks light from entering into a semiconductor layer 30a of the TFT 30, and can use, for example, a single metal including at least one of Al, Ti, Cr, W, Ta, Mo and the like, an alloy, metal silicide, poly-silicide, nitride, or a member formed by laminating these materials.

The semiconductor layer 30a of the TFT 30 includes a channel forming region, the source region, and the drain region. In this embodiment, the semiconductor layer 30a is formed of a polycrystalline silicon film, and has a lightly doped drain (LDD) structure in which a donor element such as phosphorus is contained at low concentration in a region between the channel forming region and the drain region. The semiconductor layer 30a is formed on the first interlayer insulation film 11. The semiconductor layer 30a is covered with a gate insulation film (not shown) and the gate electrode 30g is formed on the gate insulation film. The semiconductor layer 30a that faces the gate electrode 30g via the gate insulation film becomes the above channel forming region. The gate electrode 30g and the scanning line 3a are electrically connected with each other through a contact hole (not shown) penetrating through the first interlayer insulation film 11.

One of the source region and drain region of the semiconductor layer 30a is electrically connected with the signal line 6a through a contact hole CNT1, while the other one of the source region and drain region of the semiconductor layer 30a is electrically connected with the pixel electrode 15 through a contact hole CNT2. The source region and the drain region of the transistor can be changed to each other in accordance with the applied potentials; therefore, in this specification, the side that is connected with the signal line 6a is called a source region and the side that is connected with the pixel electrode 15 is called a drain region for the sake of convenience. In other words, the signal line 6a functions as a source electrode 31 of the TFT 30 and the pixel electrode 15 functions as a drain electrode 32 of the TFT 30. The contact hole CNT1 and the contact hole CNT2 are formed in the second interlayer insulation film 12.

As described earlier, the pixel electrodes 15 and the dummy electrodes 15d are formed using, for example, aluminum (Al), silver (Ag), an alloy of these metals, or a compound such as oxide, and are light-reflective. The film thickness of the pixel electrodes 15 and the dummy electrodes 15d is within a range of 50 nm to 100 nm.

The flattening insulation film 17 that covers the pixel electrodes 15 and the dummy electrodes 15d can be a silicon oxide film containing phosphorus (phospho silicate glass; called PSG), a silicon oxide film containing boron (boro silicate glass; called BSG), a silicon oxide film containing boron and phosphorus (boro-phospho silicate glass; called BPSG), or the like. The silicon oxide films containing these additives are formed by an atmospheric pressure CVD method, a low pressure CVD method, a plasma CVD method, or the like using silane gas (SiH4), dichlorosilane (SiCl₂H₂), TEOS (tetraethoxysilane/tetraethyl orthosilicate/Si(OC₂H₅)₄), TEB (tetraethyl borate), TMOP (tetramethyl oxyphosphate), or the like. In this embodiment, the BPSG film is used as the flattening insulation film 17. The silicon oxide films that contain the above-mentioned additives have an excellent property in flattening. The film thickness of the flattening insulation film 17 is approximately 100 nm.

The alignment layer 18 is formed by depositing an inorganic material such as silicon oxide (SiOₓ) by using a physical vapor deposition method (oblique deposition, oblique sputtering, or the like). The film thickness of the alignment layer 18 is approximately 75 nm.

On the liquid crystal layer 50 side of the opposite substrate 20 that is disposed facing the element substrate 10, the transparent insulation film 22 covering a black matrix (BM), the transparent conductive layer 23, and the alignment layer 25 are formed in that order. The black matrix (BM) is formed in lattice form extending in the X and Y directions in a plan view on the opposite substrate 20 so as to define the pixels P, the dummy pixels DP, and the like; note that the black matrix and the parting section 21 are formed at the same time. The black matrix is formed using a light blocking metal such as nickel (Ni) or chromium (Cr), a compound of the stated metal, or the like. In this embodiment, Cr is deposited by a sputtering method and patterned in the lattice form. The film thickness of the Cr film is approximately 75 nm. In addition, Cr is deposited and patterned to form a guiding mark on the opposite substrate 20 that is used when the element substrate 10 and the opposite substrate 20 are bonded.

On a substrate surface of the opposite substrate 20, unevenness is produced due to the formation of the black matrix and the above-mentioned guiding mark. In order to prevent part of the transparent conductive film 23 from being damaged or deformed by the above unevenness, and to obtain the smoothness of the transparent conductive film 23 at the time of forming the transparent conductive film 23, the transparent insulation film 22 for covering the surface of the opposite substrate 20 is formed. The transparent conductive film 23 functions as the common electrode, and is a conductive polycrystalline film. In this embodiment, a polycrystalline indium tin oxide (ITO) is used as the transparent conductive film 23. Like the flattening insulation film 17, the transparent insulation film 22 is formed with a silicon oxide film containing the additives. In this embodiment, the transparent insulation film 22 is formed with the BPSG film.

At the time of light display in the display region E of the reflection-type liquid crystal device 100, incident light coming from the opposite substrate 20 side (incident light IL) passes the liquid crystal layer 50, and is reflected by the pixel electrode 15 as first reflected light R1. The first reflected light R1 travels tracing along the incidence path of the light, passes again the liquid crystal layer 50, and then is outputted from the opposite substrate 20 side as output light OL. On the other hand, at the time of dark display (black display) in the display region E of the liquid crystal device 100, it is ideal that all the incident light IL is absorbed in the liquid crystal layer 50. The dark display (black display) is always performed in the dummy region D, and it is also ideal that all the incident light IL is absorbed in the liquid crystal layer 50 like in the case of the display region E being displayed in black.

### Display Mode

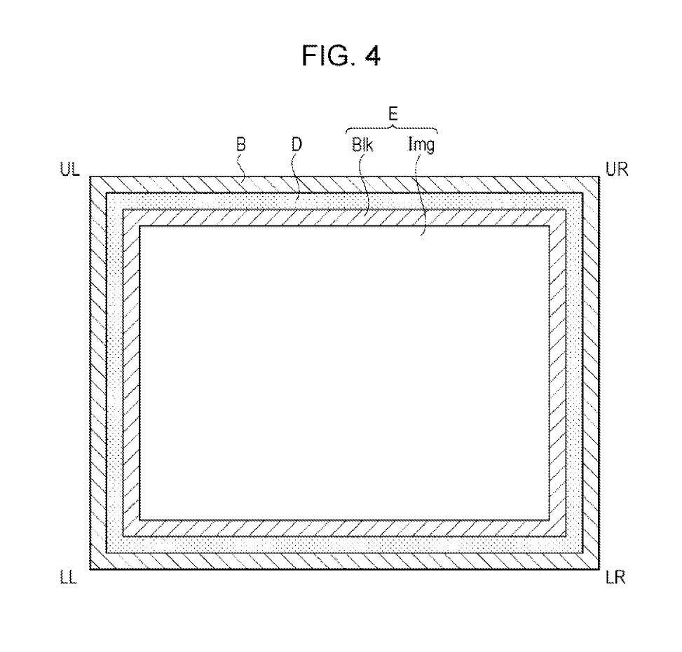

FIG. 4 is a descriptive view illustrating a display shape of the electrooptic device in a plan view from an incident light side. Next, a display mode of the liquid crystal device 100 will be described with reference to FIG. 4.

As shown in FIG. 4, the display region E includes an image region Img and a black display region Blk. The display region E is a region where an image can be displayed in the electrooptic device. Meanwhile, the image region Img is a region where an image is actually displayed within the display region E. The black display region Blk, which is different from the image region Img, is a region where the pixels P are displayed in black within the display region E. As described above, the reflectance of the pixel P displayed in black takes the minimum value. Needless to say, it is possible to display an image in the black display region Blk. Accordingly, the display region E is larger in size than the image region Img, and the number of pixels in the display region E is greater than that in the image region Img. To be more specific, it is preferable that the number of pixels disposed in the vertical direction of the display region E be greater than the number of pixels disposed in the vertical direction of the image region Img by an integer multiple of 8 (1 in this embodiment), and that the number of pixels disposed in the horizontal direction of the display region E be greater than the number of pixels disposed in the horizontal direction of the image region Img by an integer multiple of 8 (2 in this embodiment). This makes it easier to carry out signal processing. For example, in this embodiment, since the image region Img corresponds to a full high vision image of vertical 1,080 pixels with horizontal 1,920 pixels, the display region E is configured of vertical 1,088 pixels with horizontal 1,936 pixels. To rephrase, the scanning lines 3a of m=1,088 in number and the signal lines 6a of n=1,936 in number are provided within the display region E, and a full high vision image of vertical 1,080 pixels with horizontal 1,920 pixels is displayed within each display region. With this, as will be described later, in the case where a plurality of electrooptic devices are used in an electronic apparatus such as a projection-type display apparatus, it is possible to electrically adjust the position of the image region Img to be provided in the display region E and adjust the images of the plurality of electrooptic devices to make them match each other.

On the outside of the display region E, the dummy region D is formed in a frame-like shape, and the parting region B is formed so as to overlap with the outer circumference of the dummy region D. Because FIG. 4 is a plan view of the liquid crystal device 100 when viewed from the incident light side, a portion of the dummy region D that overlaps with the parting region B is not illustrated. The parting region B also serves as a black matrix, and is colored black. Therefore, in the case where the electrooptic device is used in a projection-type display apparatus, which will be explained later, the black display is performed in the parting region B. As described earlier, the dark display (black display) is always performed in the dummy region D. Moreover, the black display region Blk is displayed in black with the reflectance thereof being the minimum. With this, the opening region A includes the display region E and a part of the dummy region D that is displayed in black, and the other part thereof is optically blocked by the parting region B. In other words, because the surrounding area of the display region E is optically blocked by the dummy region D displayed in black and the parting region B, it is possible to display only the display region E within the opening region A.

As shown in FIG. 8B, in the case of where the reflectance of the electrooptic device driven in the normally black mode takes a minimum value of 0% at a voltage Vm that is applied to the electrooptic material, if the potential of the dummy electrode 15d is made equal to the potential of the common electrode, the reflectance of the dummy electrode 15d takes a value that is different from and slightly higher than the minimum 0% at the time of dark display. In this embodiment, by considering the shape of the dummy electrode 15d, the mean reflectance of the overall dummy region D can be made equal to or less than the mean reflectance of the overall black display region Blk although the reflectance of the dummy electrode 15d at the time of dark display is slightly higher than the minimum value. This will be described in detail below.

### Shape of Dummy Electrode

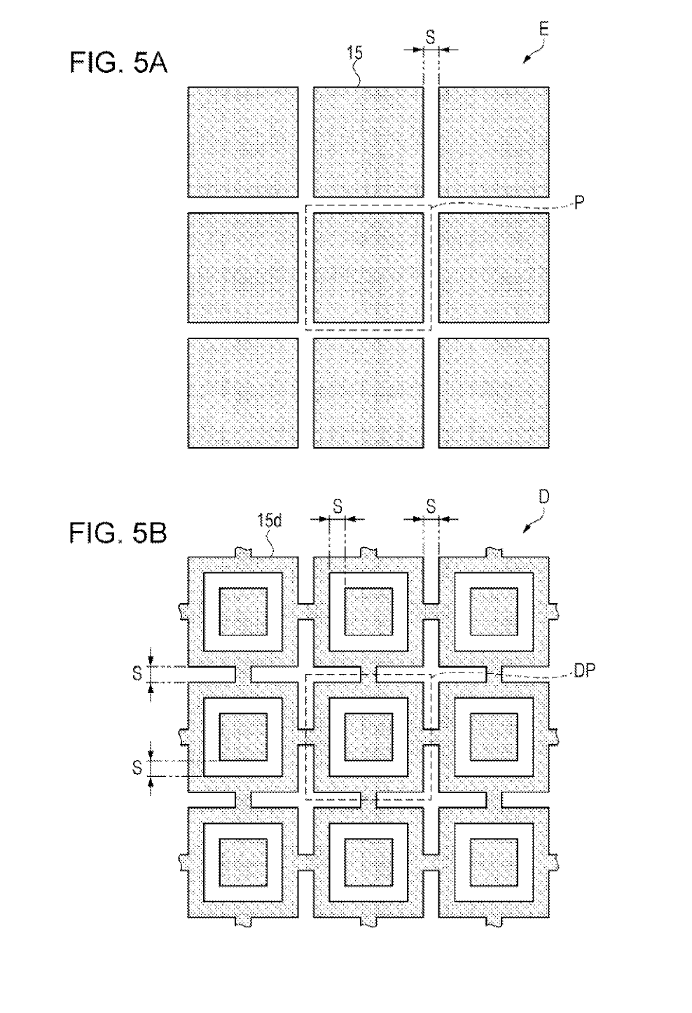

FIGS. 5A and 5B are descriptive diagrams illustrating examples of shapes of a pixel electrode and a dummy electrode in a plan view; FIG. 5A explains an example of the pixel electrode and FIG. 5B explains an example of the dummy electrode. Next, the shape of the dummy electrode in a plan view will be described with reference to FIGS. 5A and 5B.

As shown in FIG. 5A, the pixel electrodes 15 are formed in the same shape and regularly disposed at the same pitch in the display region E. Here, a ratio of the area of the pixel electrodes 15 in the display region E is referred to as a pixel electrode density. The pixel electrode density is a ratio of the area of the pixel electrode 15 in a single pixel P. A space in the display region E where no pixel electrode 15 is formed has a width S in a plan view. The width S of the space in the plan view is defined by a minimum design rule in the manufacture of the electrooptic device, and is designed so that pixel electrode density is maximized. Note that the space between a single pixel 15 and its adjacent pixel 15 means a space where a conductive film which forms the pixel electrode 15 with aluminum (Al), silver (Ag), an alloy of these metals, or a compound such as oxide is not present; however, in reality, there exists the flattening insulation film 17 between the single pixel electrode 15 and the adjacent pixel electrode 15.

As shown in FIG. 5B, the dummy electrodes 15d are formed in the same shape and regularly disposed at the same pitch in the dummy region D. Here, a ratio of the area of the dummy electrodes 15d in the dummy region D is referred to as a dummy electrode density. The dummy electrode density is a ratio of the area of the dummy electrode 15d in a single dummy pixel DP. In this embodiment, the pixel P and the dummy pixel DP are formed in the same square shape having the same area size. As for the dummy pixels DP, in addition to a space for separating the respective dummy electrodes 15d, there is provided a space within each dummy pixel DP. This space, like the above-mentioned space, means a space where a conductive film which forms the dummy electrode 15d with aluminum (Al), silver (Ag), an alloy of these metals, or a compound such as oxide is not present; however, in reality, there exists the flattening insulation film 17 in the space within each dummy pixel DP. As a result, the dummy electrode density is smaller than the pixel electrode density. With this, it is possible to cause the mean reflectance of the dummy region D to be smaller than the mean reflectance of the display region E when the same potential is applied to the pixel electrodes 15 and the dummy electrodes 15d because the dummy electrode density is smaller than the pixel electrode density. That is, in the case where the reflectance of the electrooptic device driven in the normally black mode comes to the minimum 0% at the voltage Vm that is applied to the electrooptic material, even if the potential of the dummy electrode 15d is made to be the same as that of the common electrode, it is possible to make the mean reflectance of the overall dummy region D equal to or less than the mean reflectance of the overall black display region Blk because the dummy electrode density is smaller than the pixel electrode density.

The dummy electrode density is larger than 0.5 times and smaller than 1 time the pixel electrode density. Since the dummy electrode density is smaller than the pixel electrode density, there is no doubt that the dummy electrode density is smaller than 1 time the pixel electrode density. Meanwhile, as shown in FIG. 5B, the space where no dummy electrode 15d is formed in the dummy region D also has the width S in a plan view. That is, the width S of the space where no pixel electrode 15 is formed in the display region E in the plan view is substantially equal to the width S of the space where no dummy electrode 15d is formed in the dummy region D in the plan view. Accordingly, the width S of the space where no dummy electrode 15d is formed in the dummy region D in the plan view is defined by the minimum design rule in the manufacture of the electrooptic device. A lower dummy electrode density is desirable to lower the mean reflectance of the overall dummy region D. However, the dummy electrode density need be larger than 0.5 times the pixel electrode density as long as the space with no dummy pixel 15d is intended to be formed according to the minimum design rule. In other words, if the dummy electrode density is made to be larger than 0.5 times the pixel electrode density, it is possible to form the space with no dummy electrode 15d according to the minimum design rule; if the dummy electrode density is made to be less than 1 time the pixel electrode density, it is possible to make the dummy electrode density less than the pixel electrode density. Note that the dummy electrode 15d in a square-shaped island in the center of each dummy pixel DP that is isolated by the space, is connected with other dummy electrodes 15d by wiring in a lower layer, and all the dummy electrodes 15d are always at the same potential. In this embodiment, as described before, the potential of all the dummy electrodes 15d is made equal to the potential of the common electrode. In order to maintain flatness of the flattening isolation film 17, it is not preferable for the dummy electrode density to be zero (to eliminate the dummy electrodes 15d). Since the dummy electrode density is not zero (since the dummy electrodes 15d are present), the flatness of the flattening isolation film 17 can be ensured and a uniform cell gap (depth “d” of the liquid crystal layer 50) can be obtained across the overall opening region A, thereby making it possible to ensure the high display quality.

### Electronic Apparatus

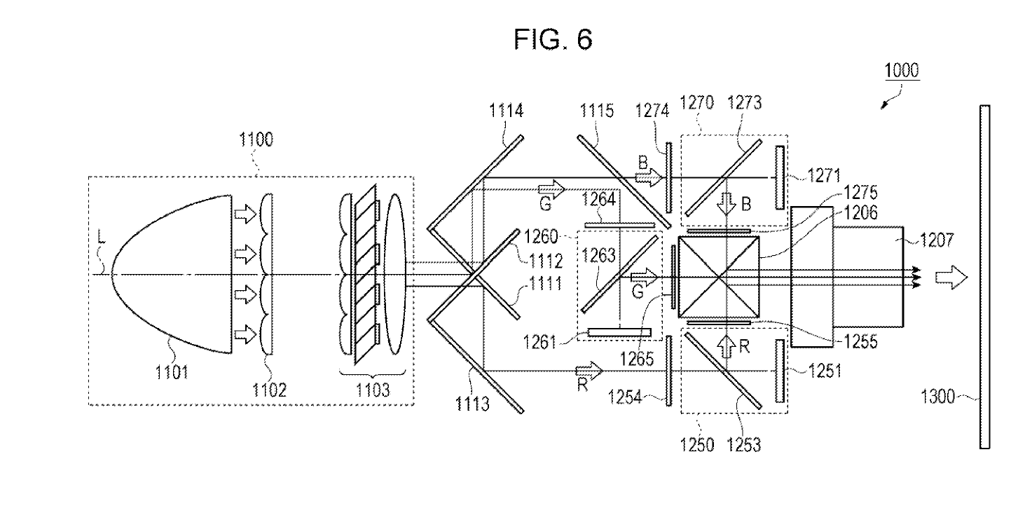

FIG. 6 is a schematic diagram illustrating the configuration of a projection-type display apparatus as an electronic apparatus. Next, the electronic apparatus of this embodiment will be described with reference to FIG. 6.

As shown in FIG. 6, a projection-type display apparatus 1000 as the electronic apparatus of this embodiment includes: a polarization lighting device 1100 disposed along a system optical axis L; three dichroic mirrors 1111, 1112, and 1115; two reflection mirrors 1113 and 1114; reflection-type liquid crystal light valves 1250, 1260, and 1270 serving as three optical modulation elements; a cross dichroic prism 1206; and a projection lens 1207.

The polarization lighting device 1100 is generally configured of a lamp unit 1101 as a light source formed with a white light source such as a halogen lamp, an integrator lens 1102, and a polarization conversion element 1103.

A polarized light flux emitted from the polarization lighting device 1100 is incident on the dichroic mirrors 1111 and 1112 that are disposed being orthogonal to each other. The dichroic mirror 1111 serving as a light separation element reflects red light R of the incident polarized light flux. The dichroic mirror 1112 serving as another light separation element reflects green light G and blue light B of the incident polarized light flux.

The reflected red light R is reflected again by the reflection mirror 113 to enter the liquid crystal light valve 1250. Meanwhile, the reflected green light G and blue light B are reflected again by the reflection mirror 1114 to be incident on the dichroic mirror 1115 serving as a light separation element. The dichroic mirror 1115 reflects the green light G and transmits the blue light B. The reflected green light G enters the liquid crystal light valve 1260. The transmitted blue light B enters the liquid crystal light valve 1270.

The liquid crystal light valve 1250 is equipped with a reflection-type liquid crystal panel 1251 and a wire grid polarizing plate 1253 as a reflection-type polarizing element. The liquid crystal light valve 1250 is disposed so that the red light R having been reflected by the wire grid polarizing plate 1253 is perpendicularly incident on an incidence surface of the cross dichroic prism 1206. Further, an auxiliary polarizing plate 1254 to help improve the polarization degree of the wire grid polarizing plate 1253 is disposed on the red light R incident side of the liquid crystal light valve 1250, and another auxiliary polarizing plate 1255 is disposed on the red light R output side along the incidence surface of the cross dichroic prism 1206. In the case where a polarization beam splitter is used as the reflection-type polarizing element, the paired auxiliary polarizing plates 1254 and 1255 can be possibly omitted. The above-described arrangement of the configuration of the reflection-type liquid crystal light valve 1250 and the configurations of the associated constituent elements is the same in the case of the other reflection-type liquid crystal light valves 1260 and 1270.

Beams of the color light having entered the liquid crystal light valves 1250, 1260, and 1270 are modulated based on image information to be incident on the cross dichroic prism 1206 respectively via the wire grid polarizing plate 1253, a wire grid polarizing plate 1263, and a wire grid polarizing plate 1273 again. In the cross dichroic prism 1206, beams of the color light are combined, and the combined light is projected onto a screen 1300 by the projection lens 1207 so that the image is enlarged and displayed thereon.

Note that in this embodiment, the above-described reflection-type liquid crystal device 100 is applied in the liquid crystal light valves 1250, 1260, and 1270 as the reflection-type liquid crystal panel 1251 and as reflection-type liquid crystal panels 1261 and 1271.

According to the projection-type display apparatus 1000 as described above, since the reflection-type liquid crystal device 100 is used in the liquid crystal light valves 1250, 1260, and 1270, it is possible to project a bright image, and to provide the projection-type display apparatus 1000 of a reflection type which can be driven at high speed.

As described thus far, in the electrooptic device of this embodiment, it is not needed to configure a dedicated circuit to the dummy electrodes and it is not needed to adopt a complicated driving system; however, it is possible to make the mean reflectance of the overall dummy region D equal to or less than the mean reflectance of the overall black display region Blk even if simply making the potential of the dummy electrodes 15d equal to the potential of the common electrode. This makes it possible to provide an electrooptic device with high display quality with ease.

The invention is not limited to the above-described embodiment, and can be appropriately modified without departing from the scope and spirit of the invention that can be understood from the aspects of the invention and the entire specification; it is to be noted that electrooptic devices on which such modifications are made and electronic apparatuses in which the stated electrooptic devices are applied are also included in the technical scope of the invention. Aside from the above embodiment, various kinds of variations can be considered. Hereinafter, such variations will be cited and explained.

### First Variation

A first variation will be described using FIG. 4. In the above embodiment, although the shape of the dummy electrode 15d is the same across the overall dummy region D and the dummy electrode density is constant in the dummy region D, they may be changed depending on their respective locations. That is, the shape of the dummy electrode 15d may be changed depending on the locations, and the dummy electrode density may be a function of the location in the dummy region D. Depending on the manufacturing methods (forming method of the alignment layer 18, for example) or the like of the electrooptic device, displayed states are different between some parts of the dummy region D, the display region E, and so on in some case. For example, in the display shape as shown in FIG. 4, depending on the alignment method, it is sometimes a case in which the reflectance of black display becomes higher in the vicinity of an upper right UR and a lower left LL at the time of dark display, and the reflectance of black display becomes lower in the vicinity of a lower right LR and an upper left UL at the time of dark display. In such case, the dummy electrode density may be lowered more in the vicinity of the upper right UR and the lower left LL of the dummy region D where the reflectance of black display becomes higher at the time of dark display than in the vicinity of the lower right LR and the upper left UL of the dummy region D where the reflectance of black display becomes lower at the time of dark display. By changing the dummy electrode density within the dummy region D in the above manner, it is also possible to make the reflectance of black display uniform within the dummy region D at the time of dark display.

### Second Variation

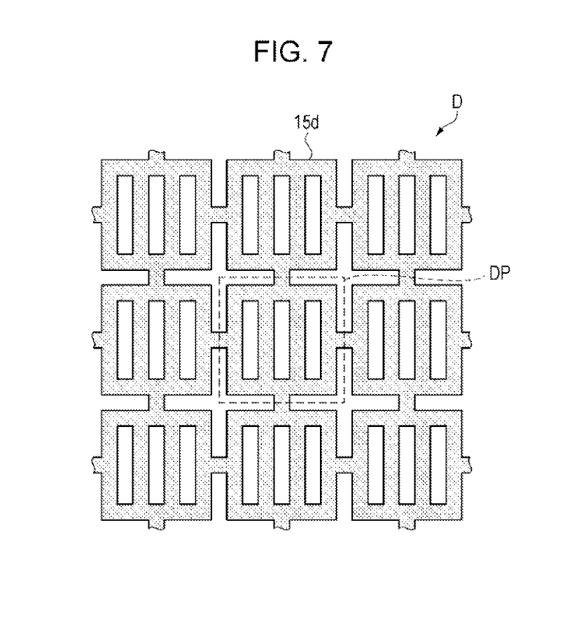

FIG. 7 is a descriptive view illustrating an example of a shape of a dummy electrode in a plan view. The shape of the dummy electrode 15d of the electrooptic device to which the invention is applied is not limited to FIG. 5; that is, the dummy electrode 15d can be formed in various shapes. For example, it may be formed in a vertical lattice shape as shown in FIG. 7, or may be formed in other shapes.

### Third Variation

The alignment control of liquid crystal molecules in the liquid crystal layer 50 of the electrooptic device to which the invention is applied is not limited to VA (vertical alignment). The invention can be applied to TN (twisted nematic), OCB (optically compensated bend), and so on.

### Fourth Variation

Electronic apparatuses in which the electrooptic device of the above embodiment can be applied are not limited to the projection-type display apparatus 1000 of the above embodiment. For example, the electrooptic device of the embodiment can be appropriately used as a projection-type HUD (head-up display), a direct-view HMD (head-mounted display), or a display unit of an information terminal apparatus such as an electronic book, a personal computer, a digital still camera, a liquid crystal television, a video recorder of a viewfinder type or a direct-view monitor type, a car navigation system, an electronic notebook, and a POS terminal and so on.

The entire disclosure of Japanese Patent Application No. 2012-244180, filed Dec. 6, 2012 is expressly incorporated by reference herein.

What is claimed is:

1. An electrooptic device comprising:
a first substrate;
a second substrate that is disposed facing the first substrate;
an electrooptic material that is sandwiched between the first substrate and the second substrate;
pixel electrodes that are disposed in a display region; and
dummy electrodes that are disposed in a dummy region surrounding the display region,
wherein a ratio of an area of the dummy electrodes in the dummy region is smaller than a ratio of an area of the pixel electrodes in the display region.

2. The electrooptic device according to claim 1,
wherein the ratio of the area of the dummy electrodes in the dummy region is larger than 0.5 times and less than 1 time the ratio of the area of the pixel electrodes in the display region.

3. The electrooptic device according to claim 1,
wherein a width in a plan view of a space where the dummy electrode is not formed in the dummy region is substantially equal to a width in a plan view of a space where the pixel electrode is not formed in the display region.

4. The electrooptic device according to claim 1,
wherein the second substrate includes an opening region and a parting region provided in a surrounding area of the opening region, and a boundary between the opening region and the parting region overlaps with the dummy region in a plan view.

5. The electrooptic device according to claim 4,
wherein the opening region has a light transmitting property and the parting region has a light blocking property.

6. An electrooptic device comprising:
a first substrate;
a second substrate that is disposed facing the first substrate;
an electrooptic material that is sandwiched between the first substrate and the second substrate;
a light blocking film that is so disposed as to surround a display region when viewed from above;
pixel electrodes that are disposed in the display region; and
peripheral electrodes that are disposed in a periphery of the display region,
wherein a ratio of an area of the peripheral electrodes in a region between the display region and the light blocking film is smaller than a ratio of an area of the pixel electrodes in the display region when viewed from above.

7. An electronic apparatus comprising the electrooptic device according to claim 1.

8. An electronic apparatus comprising the electrooptic device according to claim 6.
